(19) United States
(12) Patent Application Publication
(10) Pub. No.: US 2026/0071784 A1
(43) Pub. Date: Mar. 12, 2026

(54) Revolving Sun-Tracking Structure

(71) Applicant: Arlyn Wall, Milaca, MN (US)

(72) Inventor: Arlyn Wall, Milaca, MN (US)

(21) Appl. No.: 18/829,416

(22) Filed: Sep. 10, 2024

(51) Int. Cl. F24S 50/20; F24S 30/00; F24S 30/422

(52) U.S. Cl. CPC F24S 50/20; F24S 30/422; F24S 2030/11

(57) ABSTRACT

A revolving sun-tracking structure includes a base having a center, a first face, a second face opposite the first face, and an outer edge. Affixed to the second face is an axle with first and second ends, and a second axle with third and fourth ends. Wheels are rotationally coupled with the ends, configured for rotation, and one such wheel is a drive wheel. A drive unit is affixed to the second face, wherein the drive unit is rotationally coupled to the drive wheel. Furthermore, the revolving sun-tracking structure includes a solar sensor array attached to the first face along the outer edge of the base, configured to detect solar radiation intensity and communicate electronically with a control unit attached to the second face. Such configuration allows for the base to rotate such that the revolving sun-tracking structure maintains a neutral position relative to solar radiation exposure, maximizing such exposure.

### CROSS-REFERENCE TO RELATED APPLICATIONS

The present application does not claim priority to any U.S. Provisional or Non-Provisional patent applications.

### BACKGROUND

The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

The following is a tabulation of documents that appear to be potentially relevant at the time of filing:

| Document Number | Kind Code | Issue Date | Patentee |
|---|---|---|---|
| 4,379,588 | A | Apr. 12, 1983 | Donald G. Speice |
| 5,897,163 | A | Apr. 27, 1999 | Andrew Singer |
| 5,975,630 | A | Nov. 2, 1999 | Diana M. Schreiber |

Sun exposure, particularly in localities at far northern and southern latitudes, is highly dependent on seasonal effects, reaching a maximum near the summer solstice and gradually decreasing until reaching a minimum near the winter solstice. The greater the distance from the equator, the greater the disparity between sun exposure in a locality at the summer and winter solstices will be. The decreased winter sun exposure can result in a variety of negative impacts, from decreased temperatures and shortened crop growing seasons to human mood disorders, such as seasonal affective disorder.

Certain inventions are currently offered to mitigate these negative impacts, such as antidepressants or artificial light therapies to treat seasonal affective disorder, and greenhouses and sunrooms to collect sunlight and retain heat to thereby extend a crop's growing season and allow for later harvest. While certain sun-tracking tanning apparatuses do exist that may theoretically assist in mitigating the impacts of seasonal affective disorder, current apparatuses are not suitably adapted for the winter environment associated with decreased sun exposure near the winter solstice.

Furthermore, current devices typically only address one area of reduced sun exposure mitigation and do so in an inefficient manner. For example, it is generally understood that solar radiation transmission through a material is maximized when the incoming solar radiation is perpendicular to the material, thereby leading to the greatest sun exposure to whatever lies beyond the material, be it plants or humans. However, current solutions are generally static, and thus must estimate a single sun-incidence angle in an attempt to maximize solar efficiency. Even so, with a static structure, efficiency in solar radiation collection will fluctuate widely throughout the day and season. Current solutions that are not static generally lack the ability to retain solar radiation collected or heat generated from a non-solar source, making them ill-equipped for winter environments. Finally, current solutions are generally tailored to mitigating only one of myriad issues caused by decreased solar exposure.

### SUMMARY

In one or more examples, a revolving sun-tracking structure may include a base having a center, a first face, a second face opposite the first face, and an outer edge. An axle may be affixed to the second face, the axle having first and second ends. Perpendicular to the axle may be a second axle, likewise affixed to the second face, wherein the second axle has third and fourth ends. Wheels may be rotationally affixed to the first, second, third, and fourth ends, wherein one wheel may be a drive wheel. A drive unit and a control unit may also be affixed to the second face. The control unit and drive unit may be electrically coupled, further electronically coupled to a solar sensor array affixed to first face along the outer edge. The solar sensor array may be configured to detect solar radiation intensity relative to a horizontal axis, thereby directing rotational motion of the base by engaging the control unit, the control unit engaging the drive unit, and the drive unit rotating the drive wheel.

In one or more examples, a revolving sun-tracking structure may include a base with a center, an unobstructed access port at the center, walls affixed to the base, wherein one wall is a rear wall, and one wall is a wall with a solar-transmissible face. The wall with a solar-transmissible face may be constructed of a material, or have a coating allowing for, transmission of solar radiation. A roof may also be included, positioned between the rear wall and the wall with a solar-transmissible face. The revolving sun-tracking structure may further include an angle relative to the base and the wall with a solar-transmissible face, configured to maximize solar radiation transmission.

### BRIEF DESCRIPTION OF THE DRAWINGS

FIG. 1 shows a perspective view of an example of a revolving sun-tracking structure.

FIG. 2A shows a perspective view of an example of the revolving sun-tracking structure of FIG. 1 showing features of the underside of the revolving sun-tracking structure in detail with an unobstructed access port at the center.

FIG. 2B shows a perspective view of an example of the revolving sun-tracking structure of FIG. 1 showing features of the underside of the revolving sun-tracking structure in detail with an unobstructed access port at the rotational center.

FIG. 2C shows a perspective view of an example of the revolving sun-tracking structure of FIG. 1 showing features of the underside of the revolving sun-tracking structure in detail with the example having caster-type wheels.

FIG. 3A shows a perspective view of an example of the revolving sun-tracking structure of FIG. 1 with additional axles and wheels providing additional support.

FIG. 3B shows a perspective view of an example of the revolving sun-tracking structure of FIG. 3A with an additional drive unit.

FIG. 4 shows a perspective view of an example of the sun-tracking structure of FIG. 1 providing a canopy.

FIG. 5 shows an expanded cut-away view of an example of the revolving sun-tracking structure of FIG. 1 providing an anchor point for additional support.

FIG. 6 shows a perspective view of another example of a revolving sun-tracking structure having a structure atop a base and additional elements inside or incorporated into the structure.

FIG. 7 shows a partial perspective view of the revolving sun-tracking structure of FIG. 6 showing a material closed to solar radiation provided to cover the wall with a solar-transmissible face.

FIG. 8 shows a cut-away perspective view providing elements of the interior of the revolving sun-tracking structure of FIG. 6.

FIG. 9 shows a perspective view of another example of a revolving sun-tracking structure whereby the angle of the wall with a solar-transmissible face may be adjusted by rotational motion.

### DETAILED DESCRIPTION

Prior to describing the examples of a “revolving sun-tracking structure” in detail, it is to be understood that this disclosure is not meant to be limited to the details of construction or arrangements of the components set forth in the following description or illustrated in the drawings. Examples of this disclosure are capable of other examples, arranged with other components. Also, it can be understood that the phraseology and terminology employed herein are for the purposes of this description and should not be regarded as limiting.

For ease of understanding and clear orientation of spatial direction in the description of the below listed revolving sun-tracking structure examples and elements thereof, the use of the directions such as “right”, “left”, “up”, “down”, “forward”, “back”, “under”, “beneath”, “below”, “over”, “above”, “front”, and “rear” shall be consistent with the conventional human understanding of these directions for a human of standard orientation in space.

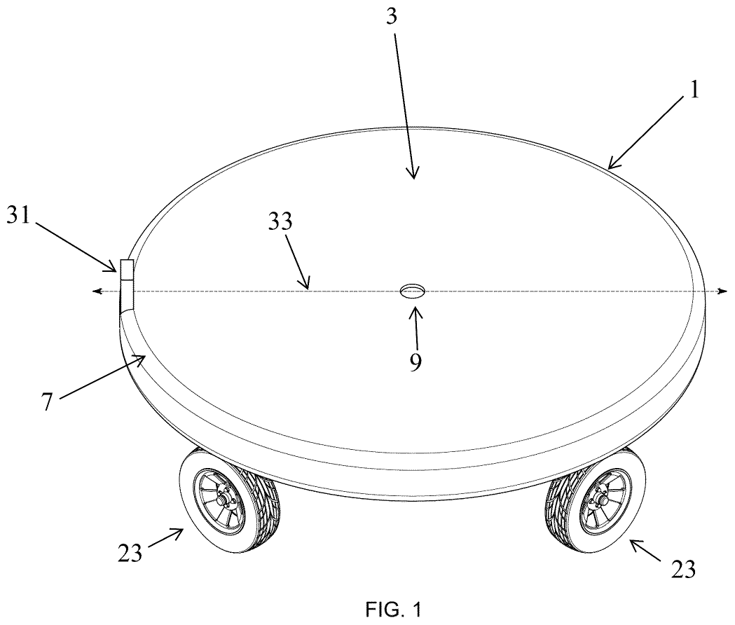

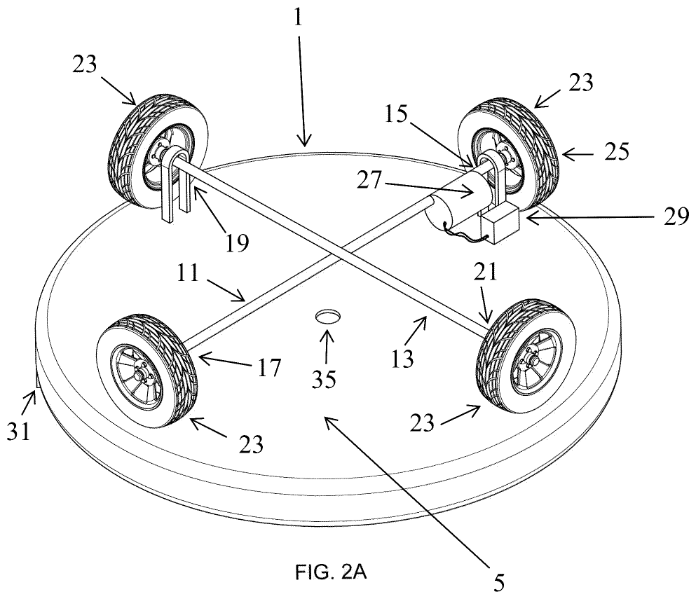

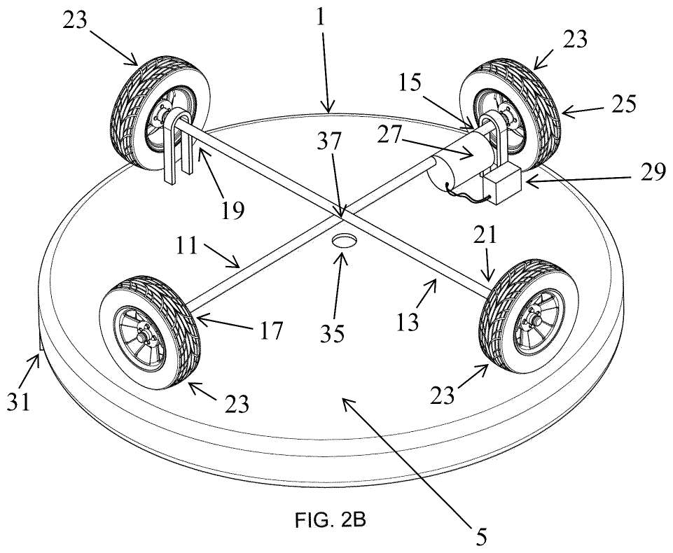

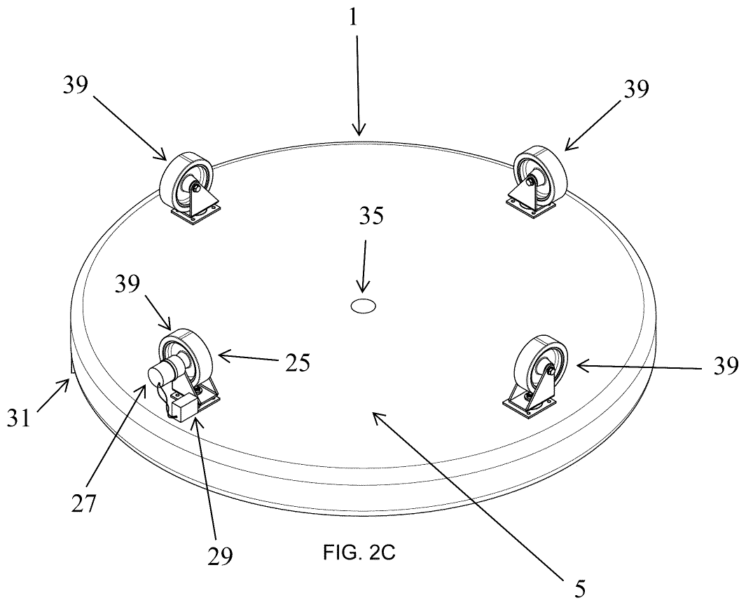

Now referencing FIGS. 1 and 2A, which illustrate a first example of a “revolving sun-tracking structure” hereinafter referenced as a “tracker”. The tracker shown may include a base 1 with a center 9, a first face 3, a second face 5, and an outer edge 7. The first face 3 is opposite the second face 5 with respect to the base 1, whereby the tracker is configured such the first face 3 is facing up and the second face 5 is facing down. An axle 11 having a first end 15 and a second end 17 opposite the first end 15 is affixed to the second face 5 to allow for free rotation of the axle 11. A second axle 13 with a third end 19 and fourth end 21 opposite of the third end 19 is likewise affixed to the second face 5, perpendicular to the axle 11, to allow for free rotation of the second axle 13. Wheels 23 are rotationally attached to the first end 15, second end 17, third end 19, and fourth end 21 and one such wheel 23 is a drive wheel 25.

A drive unit 27 is affixed to the second face 5 and rotationally coupled with the drive wheel 25. A control unit 29, affixed to the second face 5, is electronically connected the drive unit 27 thereby allowing the control unit 29 to communicate with and control the drive unit 27. Finally, a solar sensor array 31 is attached to the first face 3 along the outer edge 7, with the solar sensor array 31 electronically coupled with the control unit 29. The arrangement in the forgoing example of a tracker allows for the tracker to maintain a neutral position with respect to sun exposure along a horizontal axis 33. The solar sensor array 31 is configured to detect sun exposure on both sides of the horizontal axis 33 and activate the control unit 29 when the solar sensor array 31 detects a disparity between the sun exposure on either side of the horizontal axis 33. When the control unit 29 is thereby activated, the control unit 29 likewise activate the drive unit 27, thereby rotating the drive wheel 25 resulting in rotational motion of the tracker. Such rotation motion is continued until the solar sensor array 31 detects a neutral or equal sun exposure on both sides of the horizontal axis 33, at which time the solar sensor array 31 deactivates the control unit 29, thereby deactivating the drive unit 27 and stopping the rotational motion of the drive wheel 25 and tracker. As a result, the tracker will maintain maximum sun exposure along the horizontal axis 33. The drive unit 27 described in this example of a tracker may be solely electrically driven or may be electrically and hydraulically driven. Provided, however, that the drive method of the drive unit 27 is not limited to those described herein.

FIG. 2A, which in addition to illustrating a first example of a tracker, specifically illustrates an example of a tracker where an unobstructed access port 35 is positioned at approximately the center 9 of the base 1. The unobstructed access port 35 extends through the base 1 from the first face 3 to the second face 5. Alternatively, now referencing FIG. 2B, another example of a tracker includes the unobstructed access port 35 positioned at approximately the rotational center 37.

FIG. 2C shows another example of a tracker wherein instead of the axle 11, second axle 13, and wheels 23, a plurality of caster-type wheels 39 may be attached to the second face 5 of the base 1. One of the caster-type wheels 39 is a drive wheel 25. A drive wheel 25 is rotationally driven in the same manner, having the same remaining elements as in the example of a tracker shown in FIGS. 1 and 2A.

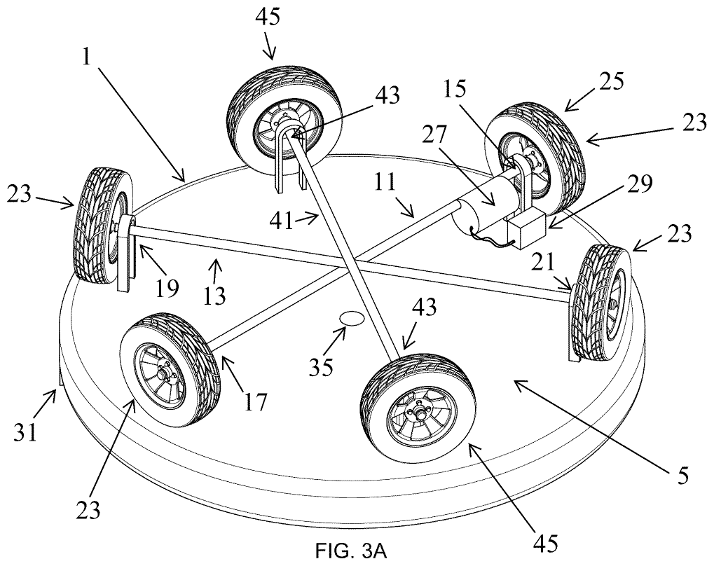

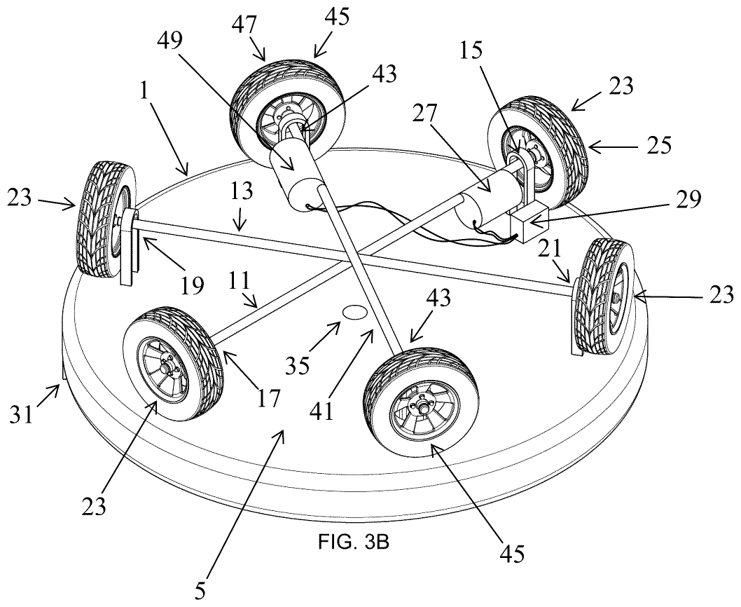

Now referencing FIG. 3A, which depicts an example of a tracker similar to the example of FIGS. 1 and 2A. This example may include a plurality of additional axles 41, each having ends 43. To each end 43, a plurality of additional wheels 45 may be rotationally affixed. A drive wheel 25 is rotationally driven in the same manner, having the same remaining elements as in the example of a tracker shown in FIGS. 1 and 2A. The additional axles 41 and additional wheels 45 may provide additional support and stabilization of the base 1. FIG. 3B illustrates the tracker of FIG. 3A, further including one or more auxiliary drive wheels 47 rotationally coupled to one or more auxiliary drive units 49, whereby the auxiliary drive wheels 47 and auxiliary drive units 49 provide additional rotational power to rotationally drive the base 1.

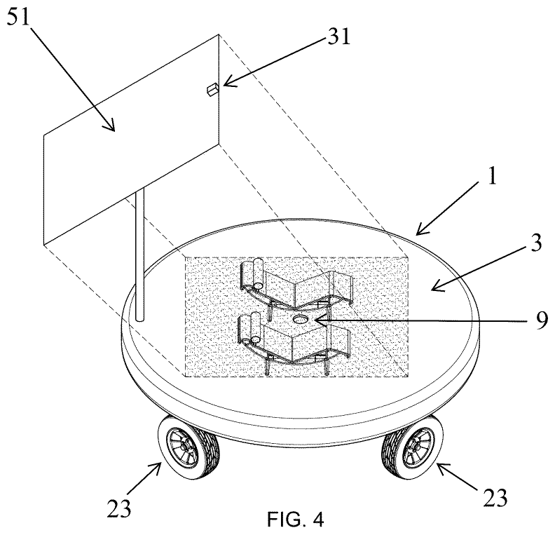

A further example of a tracker is shown in FIG. 4, which may include a canopy 51 movably coupled with the base 1 to provide shade and protection from sun exposure upon the base 1. All other elements are identical to the example shown in FIGS. 1 and 2A, except that the solar sensor array 31 is affixed on top of the canopy 51.

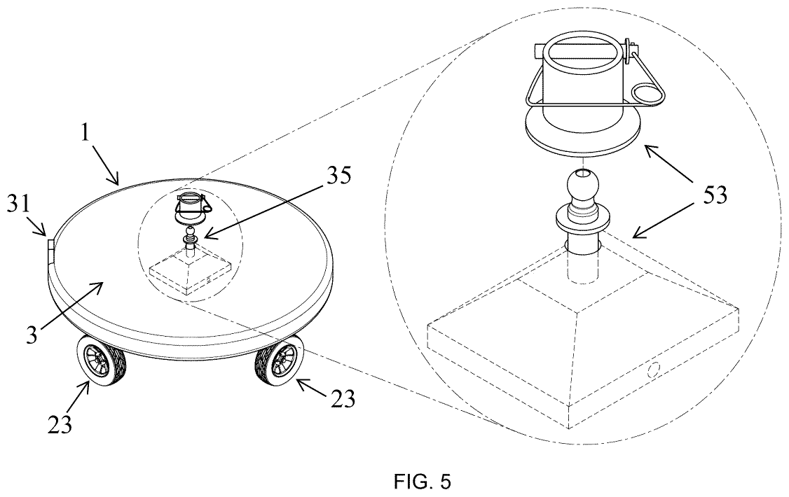

FIG. 5 depicts the tracker of FIGS. 1 and 2A with an anchor point 53 at the center 9 of the base 1, extending through unobstructed access port 35. The anchor point 53 may provide for additional support of the base 1 during rotation of the base 1.

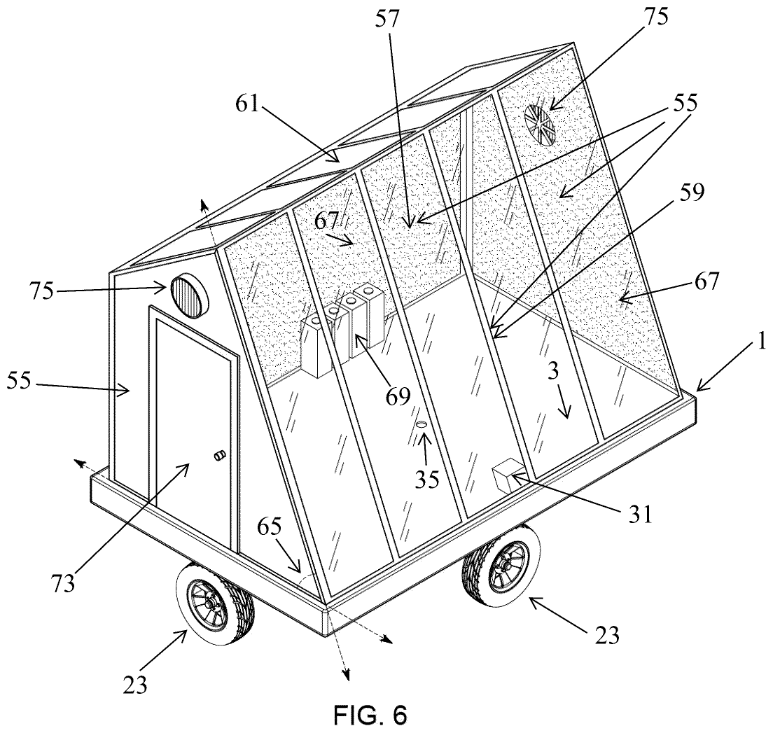

The tracker depicted by FIG. 6 is similar to the example shown in FIGS. 1 and 2A with additional elements. The example shown by FIG. 6 additionally includes walls 55 affixed to the first face 3, wherein one wall 55 is a rear wall 57, and one wall 55 is a wall with a solar-transmissible face 59. Connected to the walls 55, between the rear wall 57 and wall with a solar-transmissible face 59 is a roof 61. The Solar sensor array 31 is attached to the base 1 along the outer edge 7 where the wall with a solar-transmissible face 59 is located. The wall with a solar-transmissible face 59 allows for solar radiation to be transmitted into the interior of the structure formed by the walls 55 and roof 61. As explained in more detail in other examples, the arrangement of elements in this example of a tracker will allow the tracker to rotate to maintain a position whereby the wall with a solar-transmissible face 59 is perpendicular with the incidence of solar radiation, thus maximizing solar radiation transmission.

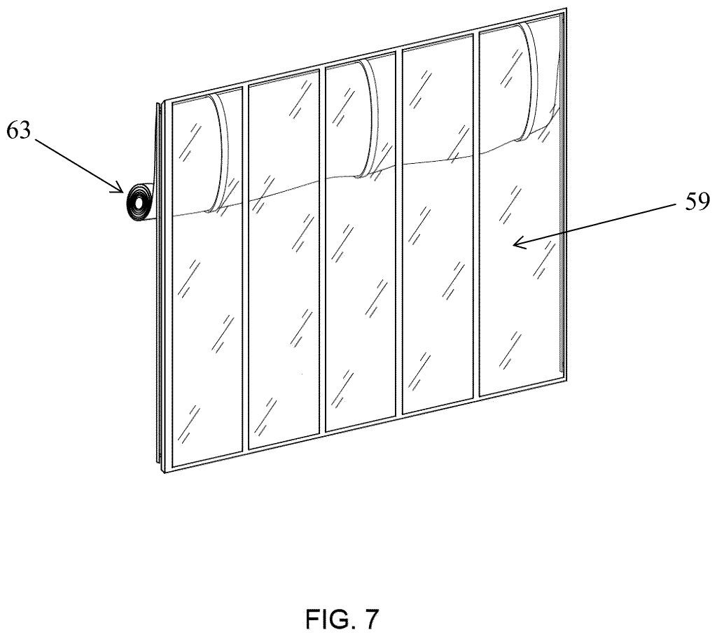

Now referencing FIG. 7, which illustrates a cut away view of the wall with a solar-transmissible face 59. To the wall with a solar-transmissible face 59, a secondary face 63 may be attached and configured for removably covering the wall with a solar-transmissible face 59. The secondary face 63 is constructed of a material closed to solar radiation, thereby allowing solar radiation transmission to be blocked when the secondary face 63 covers the wall with a solar-transmissible face 59.

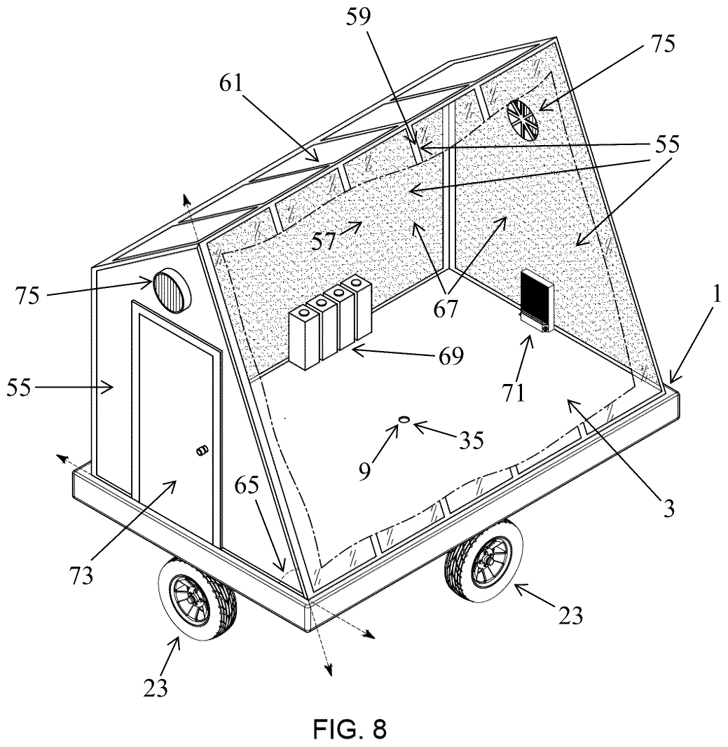

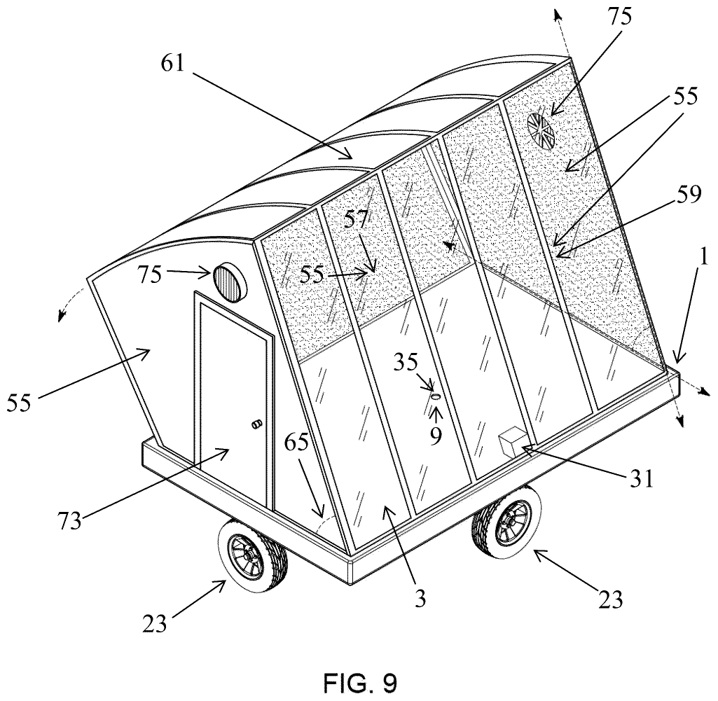

Another example of a tracker, shown in FIG. 8, may include a base 1 having a center 9. At the center 9 is an unobstructed access port 35. Walls 55 may be affixed to the base 1, wherein one wall 55 is a rear wall 57, and one wall 55 is a wall with a solar-transmissible face 59. Connected to the walls 55, between the rear wall 57 and wall with a solar-transmissible face 59 is a roof 61. Relative to the base 1 and the wall with a solar-transmissible face 59 is an angle 65. The angle 65 may be between 45 degrees and 90 degrees to optimize collection of solar radiation. However, the angle 65 may also be angels outside of the 45 degrees to 90 degrees range is so required to optimize collection of solar radiation. The walls 55 may be constructed of, or have attached to them, an insulative material 67 to better retain heat generated by transmitted solar radiation. To further retain heat generated by transmitted solar radiation, the tracker may include heat storage units 69 positioned along the rear wall 57. To increase temperature within the structure formed by the walls 55 and roof 61, the tracker may also include one or more auxiliary heating units 71. For ease of access into the structure formed by the walls 55 and roof 61, the tracker may further include a door 73 on a wall 55. Finally, to increase airflow within the structure formed by the walls 55 and roof 61, one or more vents 75 may be included in one or more walls 55. The vents 75 may be passive, or active driven by a fan or other active, powered system. FIG. 9 illustrates the tracker of FIG. 8, wherein the angle 65 is adjustable by rotational movement of the solar-transmissible face 59.

From the description above several advantages of some examples of the harness are possible:

a. Maximization of solar radiation transmission, collection, or storage by the tracker being capable of maintaining a position perpendicular to the incidence of solar radiation.

b. Maximization of solar radiation transmission, collection, or storage by the wall with a solar-transmissible face being perpendicular to the incidence of solar radiation.

c. Maximization of solar radiation transmission, collection, or storage by the angle being adjustable to maintain a position the wall with a solar-transmissible face perpendicular to the incidence of solar radiation regardless of season or latitude.

d. Providing for a tracker that allows for maximum solar radiation exposure and a comfortable interior temperature during cool seasons, assisting in the management of seasonal affective disorder.

e. Providing for a tracker that allows for maximum solar radiation exposure and collection, and an adequate growing temperature, thereby extending the plant growing season in cooler climates.

While only selected examples have been chosen to illustrate the present invention, it will be apparent to those skilled in the art from this disclosure that various changes and modifications can be made herein without departing from the scope of the invention as defined in the appended claims. For example, the size, shape, location, or orientation of the various components can be changed as needed or desired. Components that are shown directly connected or contacting each other can have intermediate structures disposed between them. The functions of one element can be performed by two, and vice versa. The structures and functions of one example can be adopted in another example. It is not necessary for all advantages to be present in a particular example at the same time. Every feature which is unique from the prior art, alone or in combination with other features, also should be considered a separate description of further inventions by the applicant, including the structural or functional concepts embodied by such feature(s). Thus, the foregoing descriptions of the examples according to the present invention are provided for illustration only, and not for the purpose of limiting the invention as defined by the appended claims and their equivalents.

What is claimed is:

1. A revolving sun-tracking structure comprising:
a base having a center, a first face, a second face opposite the first face, and an outer edge;
an axle affixed to the second face, wherein the axle has a first end and a second end;
a second axle affixed to the second face perpendicular to the axle, wherein the second axle has a third end and a fourth end;
wheels attached to the first end, the second end, the third end, and the fourth end, configured for rotation therewith, wherein one wheel is a drive wheel;
a drive unit attached to the second face, wherein the drive unit is rotationally coupled with the drive wheel;
a solar sensor array attached to the first face along the outer edge, configured to detect sunlight's intensity relative to a horizontal axis, and configured to communicate electronically with a control unit; and
the control unit attached to the second face, wherein the control unit is electronically coupled with the drive unit;
wherein the drive unit is configured to rotate the drive wheel, rotating the base, until the solar array detects a neutral solar position.

2. The revolving sun-tracking structure of claim 1, further comprising:
walls affixed to the first face, wherein one wall is a rear wall, and one wall is a wall with a solar-transmissible face; and
a roof connected to the walls, arranged between the rear wall and the wall with a solar-transmissible face.

3. The revolving sun-tracking structure of claim 1, wherein an unobstructed access port extends through the base from the first face to the second face at approximately the center.

4. The revolving sun-tracking structure of claim 1, further comprising a rotational center, wherein an unobstructed access port extends through the base from the first face to the second face at approximately the rotational center, the access port having a central axis perpendicular to the first and second faces.

5. The revolving sun-tracking structure of claim 1, further comprising a plurality of additional axles, each having ends, configured for further support and stabilization of the base, and a plurality of additional wheels, wherein each wheel is rotationally affixed to an end.

6. The revolving sun-tracking structure of claim 1, further comprising one or more auxiliary drive wheels and one or more auxiliary drive units, wherein each auxiliary drive wheel is rotationally coupled to each auxiliary drive unit.

7. The revolving sun-tracking structure of claim 1, further comprising a canopy movably coupled to the base.

8. The revolving sun-tracking structure of claim 1, further comprising an anchor point at the center configured to provide rotational support to the base.

9. The revolving sun-tracking structure of claim 1, wherein the drive unit is an electrical drive.

10. The revolving sun-tracking structure of claim 1, wherein the drive unit is an electrically-driven hydraulic drive.

11. A revolving sun-tracking structure comprising:
a base having a center;
an unobstructed access port at the center;
walls affixed to the base, wherein one wall is a rear wall, and one wall is a wall with a solar-transmissible face;
a roof connected to the walls, arranged between the rear wall and the wall with a solar-transmissible face; and
an angle relative to the base and the wall with a solar-transmissible face, configured to optimize collection of UV radiation.

12. The revolving sun-tracking structure of claim 11, wherein the angle is about 45 degrees to 90 degrees.

13. The revolving sun-tracking structure of claim 11, further comprising a secondary face that is closed to UV radiation, configured for removably covering the wall with a solar-transmissible face.

14. The revolving sun-tracking structure of claim 11, wherein the walls further comprise insulative material.

15. The revolving sun-tracking structure of claim 11, further comprising heat storage units along the rear wall.

16. The revolving sun-tracking structure of claim 11, wherein the angle is adjustable by rotational movement of the wall with a solar-transmissible face.

17. The revolving sun-tracking structure of claim 11, further comprising one or more auxiliary heating units.

18. The revolving sun-tracking structure of claim 11, further comprising vents.

19. The revolving sun-tracking structure of claim 11, further comprising one or more doors.

20. A revolving sun-tracking structure comprising:
a base having a center, a first face, a second face opposite the first face, and an outer edge;
a plurality of caster-type wheels attached to the second face, wherein one wheel is a drive wheel;
a drive unit attached to the second face, wherein the drive unit is rotationally coupled with the drive wheel;
a solar sensor array attached to the first face along the outer edge, configured to detect sunlight's intensity relative to a horizontal axis, and configured to communicate electronically with a control unit; and
the control unit attached to the second face, wherein the control unit is electronically coupled with the drive unit;
wherein the drive unit is configured to rotate the drive wheel, rotating the base, until the solar array detects a neutral solar position.
